(19) United States
(12) Patent Application Publication
(10) Pub. No.: US 2014/0083952 A1
(43) Pub. Date: Mar. 27, 2014

(54) Apparatus and Method for Increasing the Mass Transfer of Reactants Entrained Within a Separate Gas Phase Into a Separate Flowing Liquid Phase

(71) Applicants: Angelo L. Mazzei, Bakersfield, CA (US); Celia Marie Cobar, Bakersfield, CA (US)

(72) Inventors: Angelo L. Mazzei, Bakersfield, CA (US); Celia Marie Cobar, Bakersfield, CA (US)

(21) Appl. No.: 13/626,850

(22) Filed: Sep. 25, 2012

(51) Int. Cl. C02F 1/68

(52) U.S. Cl. CPC C02F 1/68
USPC 210/749; 210/198.1

(57) ABSTRACT

The invention has to do with the re-entrainment of gases separated from a water/gas mixture that rise to the top of a conductor pipe. A water jet created by a nozzle of the present invention plunges though the surface of the water carrying with it the gas that has accumulated on the surface on the water between the water and the top of the conduit. Depending on the gas to liquid ratio and the velocity of the mainline water flow, the nozzles penetrate the conductor pipe adjacent to a point where the gas has accumulated and no longer is entrained and mixed with the water. The ratio of plunging water to main water flow is determined based on the upstream injected gas to liquid ratio for the treatment process such as oxygen for aerobic conditions or ozone for oxidation.

### FIELD OF THE INVENTION

This application is generally related to the mixing of a gas phase, including a gas having reactive components, such as ozone, into a major flow of liquid through a large conduit, where the gas phase and liquid phases have been separated by the relative densities of each, or where fluids of a high gas-liquid ratio (i.e. [gas volume]/[liquid volume], hereinafter referred to as “gas-liquid ratio”) are introduced into the conduit. Such situations may occur in installations where a bypass loop has been installed, where the bypass loop is utilized to introduce a water treatment gas, such as ozone, oxygen, chlorine, or chlorine dioxide. In this type of installation, flow from the bypass loop flows through a mixing apparatus, such as a mixing injector, and a treatment gas is introduced into the bypass stream. Once the treatment gas has been mixed with the bypass flow, the treated water is reintroduced into the conduit for the purpose of mixing with the total fluid flow in the conduit and treating all of the water. This type of installation is particularly applicable for treating waste water or potable water in municipal installations.

### BACKGROUND OF THE INVENTION

In two phase flow in generally horizontal, low pressure (e.g. 25 psig or less) and relatively large diameter (e.g., four inch or greater) pipelines, it is common to have phase separation, where the lower density gas phase, separated from the liquid in which it is initially entrained, flows in the upper portion, or headspace of the pipeline. While this phase separation is acceptable for some applications, for other applications it is desirable to have relatively homogenous flow of the gas and liquid phases, i.e., for the gas phase to be sufficiently dissolved within the liquid phase such that there is minimal flow of a separate gas phase in the headspace of the pipeline. For example, turbine flow meters are generally more reliable with single phase or homogenous flow. As another example, there are applications where the separate gas phase contains reactants which are desired to be effectively transferred to the liquid phase. For example, if a vapor phase corrosion inhibitor is utilized, effective placement of the inhibitor on the exposed metal surfaces of a pipeline typically requires that the vapor phase be dissolved within the liquid phase.

As another application, the inventor herein is the inventor of U.S. Pat. No. 7,779,864 which teaches, among other things, the diversion of some of the liquid flowing within a conduit, boosting its pressure into an aspirating injector, and adding a treatment substance, such as ozone, and returning the diverted flow stream to the conduit back into the mainstream flow for dispersion of the treatment substance. By this reference, U.S. Pat. No. 7,779,864 (“the '864 patent”) is incorporated into this disclosure in its entirety. In this type of application, it is desirable that the reactive substances within the gas phase be efficiently dissolved within the mainstream flow to provide the reactive substance where it is required, such as for treating bacteria-laden waste water.

One particular application for the present invention is the treatment of waste water or potable water from municipal and industrial sites. In the typical application, raw water from some source from which solids have already been extracted require subsequent treatment with injected treatment substances to eliminate objectionable organisms. As discussed in the '864 patent, the objective for the treatment of waste water is commonplace—the effluent water is to be clarified and purified sufficiently to be acceptable into the water distribution system. However, as further discussed in the '864 patent, the large settling ponds that could formerly be accepted are increasingly unsuitable for systems which must expand to meet an ever increasing demand. The dwell-time and consequences of known treatments were and are too costly in processing, in equipment, and in space to put the equipment.

Large flows of water in confinement as contemplated by this invention are large diameter pipes, usually 4 inches inside diameter or larger flowing full under pumped pressure, or gravity fed pipelines. Larger diameters are contemplated, and smaller ones also fall within the scope of this invention. However, the systems of greatest interest are those with flow rates between about 2 and 200 million gallons per day.

These are rapid flows into which the invention taught in the '864 patent injects treatment gas in the pipe without interruption of the major flow. With that invention, settling ponds, dwell tanks and the like become unnecessary or the need for them is greatly reduced. However, the '864 patent is generally silent regarding the size of the bypass facility, except to state that an injection stream can be properly dispersed within the main stream, i.e. quickly and uniformly taken into the mainstream, when utilized with “proper parameters.” Unfortunately, there are obstacles to achieving these proper parameters. Most importantly, the demands of the initial capital investment and the ongoing operational expenses for maintenance and energy, favor small bypass facilities. These factors greatly favor bypass systems which divert a small percentage of the overall liquid flow. With such systems, the volume of carrier liquid is significantly reduced. However, the required volume of treatment gas for all of the liquid flowing through the pipeline does not change. As a result, the fluid returned into the mainstream may have a very high gas-liquid ratio such that gas carried in the returned water will usually break out into a separate phase within a length of a few pipe diameters upon re-introduction of the carrier fluid into the conduit.

The gas-liquid ratio may be so high that phase separation occurs almost immediately upon re-introduction of the treated bypass stream back into the main conduit, such that the treatment gas separates from the liquid and flows in the headspace of the conduit (i.e., in the upper section of the conduit), while the waste water flowing in the lower section of the conduit remains largely untreated. When the volume of the diverted stream is significantly reduced, for example where the diverted stream is less than 25% of the main stream water, and if the treatment fluid is a gas, such as ozone, the gas-liquid ratio of the returning injection stream can be quite high. As a result, when the injection stream is returned into the main conduit, there may be an adverse impact on shearing thrust and velocity, resulting in a decrease of the transfer of reactive components within the gasses into solution where the reactive components are required.

### BRIEF DESCRIPTION OF THE INVENTION

The present invention is used in a confined-flow conduit under pressure such as a pipe. The system has an upstream end and an effluent end. Between these ends there is an unimpeded region of fluid flow. This fluid, through either the characteristics of the fluid itself, or by treatment processes such as the reinjection stream of the '864 patent, may contain a gas phase which, as the fluid flows through the conduit, breaks out, rises to the top of the conduit into the headspace, and flows as a separate phase from the liquid phase, potentially leaving unreacted treatment gas in the headspace and minimally treated water flowing in the lower section of the conduit.

A first embodiment of the invention comprises a generally circular conduit generally comprising a pipe wall which defines an interior of the conduit. The interior of the conduit has an upper section and a lower section. The conduit has a length through which the liquid phase and the gas phase are simultaneously flowing in separated two phase flow where, because of density separation or the injection of a fluid having a high gas-liquid ratio, a majority of the gas phase is flowing as a separate gas phase within the upper section and a majority of the liquid phase is flowing within the lower section. A plunging nozzle assembly is installed on and through the conduit, where the nozzle assembly comprises a sleeve member having a first end which penetrates the pipe wall and a second end which comprises a flange. A nozzle slides inside the sleeve member, where the nozzle has a landing member on one end which lands on the flange. At the opposite end of the nozzle is the throat of the nozzle which has a reduced diameter for jetting fluid which flows through the nozzle, where the throat of the nozzle is positioned to be downwardly facing into the interior of the conduit. A mating flange is made up to the flange on the sleeve, where the mating flange may be on a valve, spool piece, or other fitting.

A pressurized liquid supply means is hydraulically connected to the sleeve to provide for the pumping of a pressurized liquid through the plunging nozzle. The pressurized liquid supply means and the plunging nozzle are configured to discharge the pressurized liquid into the upper section through the gas phase and impacting an upper surface of the liquid phase, thereby entraining a portion of a gas in the gas phase into the liquid phase. Depending on the gas-liquid ratio and the velocity of the mainline water flow, the nozzle or nozzles are located at a point or points where the gas has accumulated and no longer is entrained and mixed with the water, and the angle of the nozzles, diameter of the nozzle throats, injection pressure, the number of nozzles, etc. may be adjusted to increase the transfer of free gas into the liquid phase. The ratio of “jetted water” or “plunging water” to main water flow is determined based on the upstream injected gas-liquid ratio for the treatment process such as oxygen for aerobic conditions or ozone for oxidation.

In order for the device to work, the fluid flowing through the nozzle must enter into the empty head space of the conduit, and not directly into the liquid phase. This is because the jetting of the fluid directly into the surface of the liquid creates a low pressure zone directly adjacent to the liquid surface, facilitating the entrainment of the free gas phase into the liquid phase. Jetting the fluid directly into the liquid phase rather than allowing the fluid to pass through the gas phase will not, it is believed, make the low pressure zone available to the gas phase, but will rather simply mix the liquid or liquids. Thus, it is important to identify the volume and therefore the position of the free gas phase. It is also desirable, but not necessary, to have multiple plunging nozzles disposed circumferentially about the upper section of the conduit, such that the volume and orientation of the fluid flowing through the plunging nozzle(s) may be adjusted as desired.

In another embodiment, the invention comprises a generally circular conduit having a length L, where the conduit has an upper arcuate section. This upper arcuate section forms the headspace into which a separate gas phase may form. The invention comprises a plurality of plunging nozzles disposed within and penetrating the upper arcuate section, with the plurality of nozzles generally located at a distance L₁ along the length, with the nozzles in circumferential alignment and within the same axial plane. Each nozzle has a body which has an axial opening extending through the body, where an axis is defined by the orientation of the axial opening of each nozzle. A pressurized liquid supply means is attached to each plunging nozzle for delivering a pressurized liquid in the conduit. The liquid jet plunges though the surface of the liquid flowing through the conduit, carrying with it the gas that has accumulated in the headspace. Depending on the gas-liquid ratio and the velocity of the mainline water flow, the placement of the nozzles are located at a point where the gas has accumulated and no longer is entrained and mixed with the water. Multiple sets of plunging nozzles may be placed along the length of a conduit to achieve the desired dissolution of the free gas phase. The use of multiple nozzle sets allows the utilization of lower liquid injection pressure at the nozzles, which means more nozzle sets can be operated with the same energy demand which, depending upon the volume of gas accumulated at the top of the conduit, accomplishes greater mass transfer.

In another embodiment of the invention, a bypass conduit extends into the unimpeded flow region of the conduit, as taught within the '864 patent. The purpose of this bypass conduit is to bypass a portion of the total stream while receiving one or more from mixer-injectors correct amounts of treatment gas, and then branching into at least one pair of injection nozzles that discharge the additive-laden fluid back into the conduit. This diversion/reinjection system is referred to as a pipeline flash reactor (“PFR”). In general, the plunging jets should be located 10 to 15 pipe diameters downstream from where the treatment gas is injected for the PFR.

As with the system disclosed in the '864 patent, the present system operates with no impediment to free flow through it, and with only a moderate loss of energy consumed by the plunging jets and, if utilized, in the operation of the bypass conduit. This is an effective small-footprint system which requires little or no separate power and little operational attention.

The above and other features of this invention will be fully understood from the following detailed description and the accompanying drawings.

### BRIEF DESCRIPTION OF THE DRAWINGS

FIG. 1 schematically depicts a conduit having both injection nozzles and plunging nozzles, showing the relative positions of each.

FIG. 2 depicts one configuration of plunging nozzles which might be utilized in embodiments of the invention.

FIG. 2A shows a detailed view of the configuration of FIG. 2.

FIG. 3 depicts an alternative configuration of plunging nozzles which might be utilized in embodiments of the invention.

FIG. 3A shows a detailed view of the configuration of FIG. 3.

FIG. 4 shows an isometric view of a conduit section having a configuration of plunging nozzles attached.

FIG. 5 shows an isometric view from the other side of the conduit section of FIG. 4.

FIG. 6 shows an end view of the conduit section of FIG. 4.

FIG. 7 shows a top view of the conduit section of FIG. 4.

FIG. 8 shows an exploded view of the conduit section of FIG. 4.

FIG. 9 shows an end view of another configuration of plunging nozzles.

FIG. 10 shows a detailed view of a configuration of sleeve member of the plunging nozzle assembly which may be utilized in embodiments of the invention.

FIG. 11. shows a detailed view of an alternative configuration of sleeve member of the plunging assembly which may be utilized in embodiments of the invention.

FIG. 12 is a schematic drawing of an embodiment of a pipeline flash reactor which may be utilized in embodiments of the invention.

FIG. 13 is a cross-section taken at line 13-13 in FIG. 12.

FIG. 14 is an axial cross-section of an embodiment of a mixing injector appropriate for use in pipe line flash reactor depicted in FIG. 12.

FIG. 15 is an axial cross-section of a nozzle which may be utilized for both gas injection and liquid injection in the disclosed embodiments of the invention.

### DETAILED DESCRIPTION OF THE INVENTION

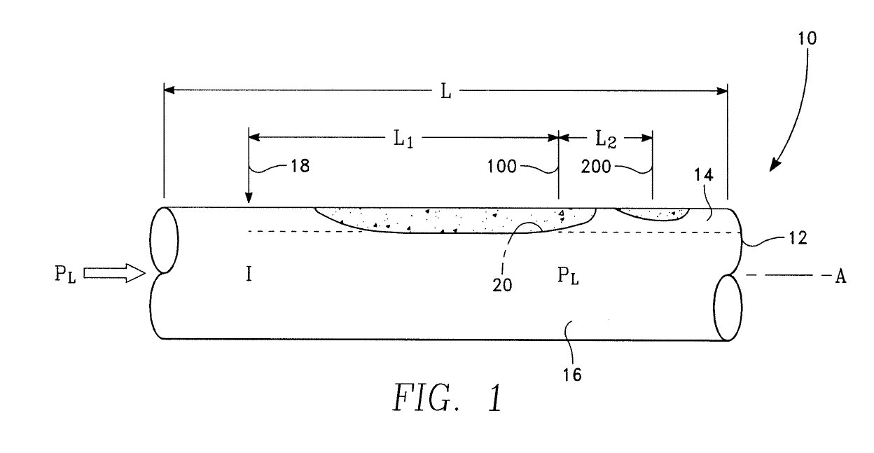

A pipe or conduit 10 for carrying a substantial flow of water is schematically depicted in FIG. 1. As shown, conduit 10 is generally circular has a wall 12. The conduit 10 has a length L, through which, at least for part of length L, a liquid phase P_{L} and a gas phase P_{G} are simultaneously flowing in separated two phase flow as shown in FIG. 1. The conduit 10 has an interior I defined by the wall 12. The interior I has an an upper section 14 and a lower section 16. Because of the phase separation which occurs in the conduit 10 downstream of gas injection point 18 a majority, if not substantially all, of the gas phase P_{G} is contained within the upper section 14 and a majority, if not substantially all, of the liquid phase P_{L} is contained within the lower section 16 between the gas injection point 18 and the plunging nozzle assembly 100. Plunging nozzle assembly 100 is placed a distance L₁ from gas injection point 18. A second plunging nozzle assembly 200 may be placed a distance L₂ from plunging nozzle assembly 100. Additional plunging nozzle assemblies may be added as desired or required to insure effective dispersion of treatment gas into the liquid phase P_{L} or to achieve the desired flow regime within the conduit 10.

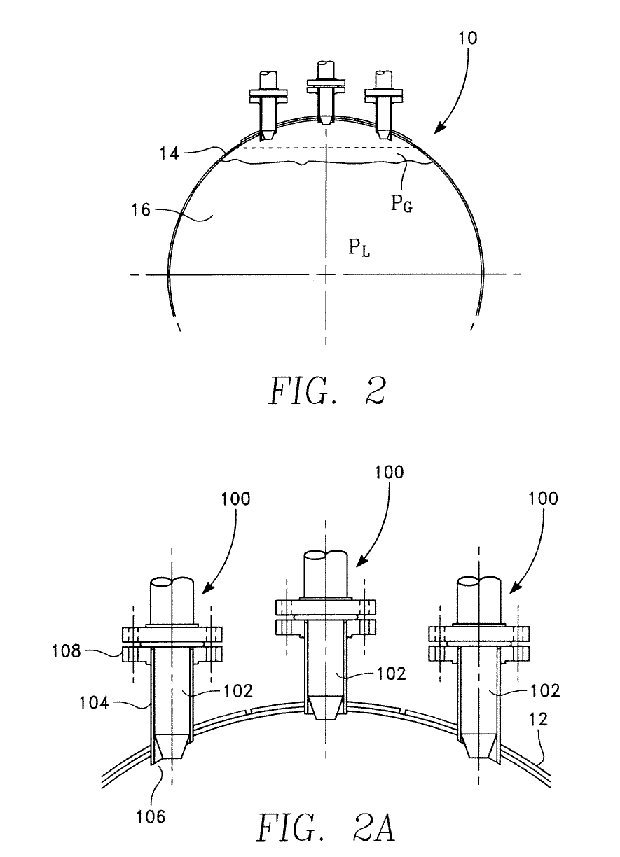

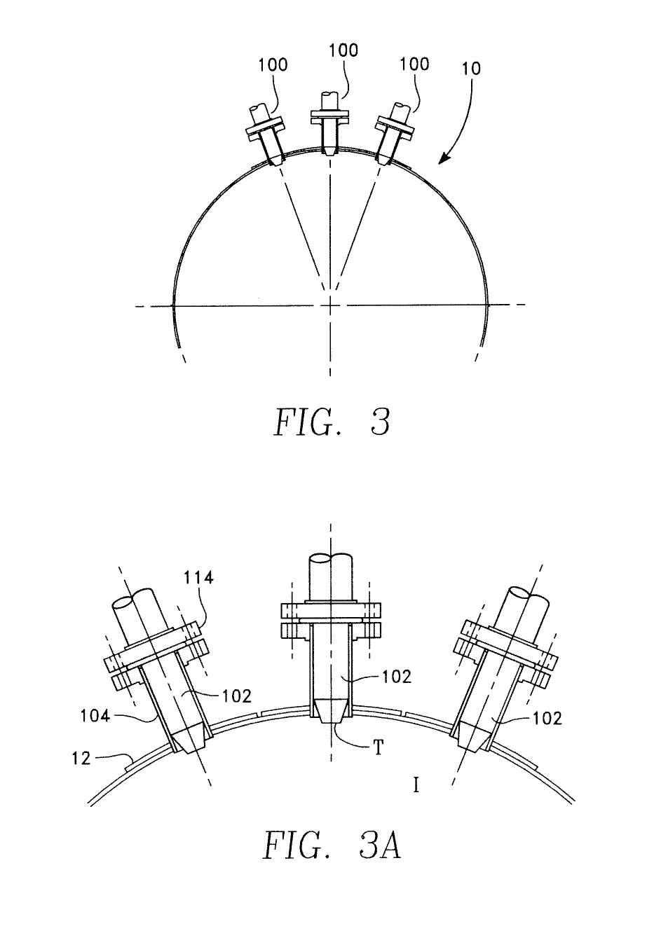

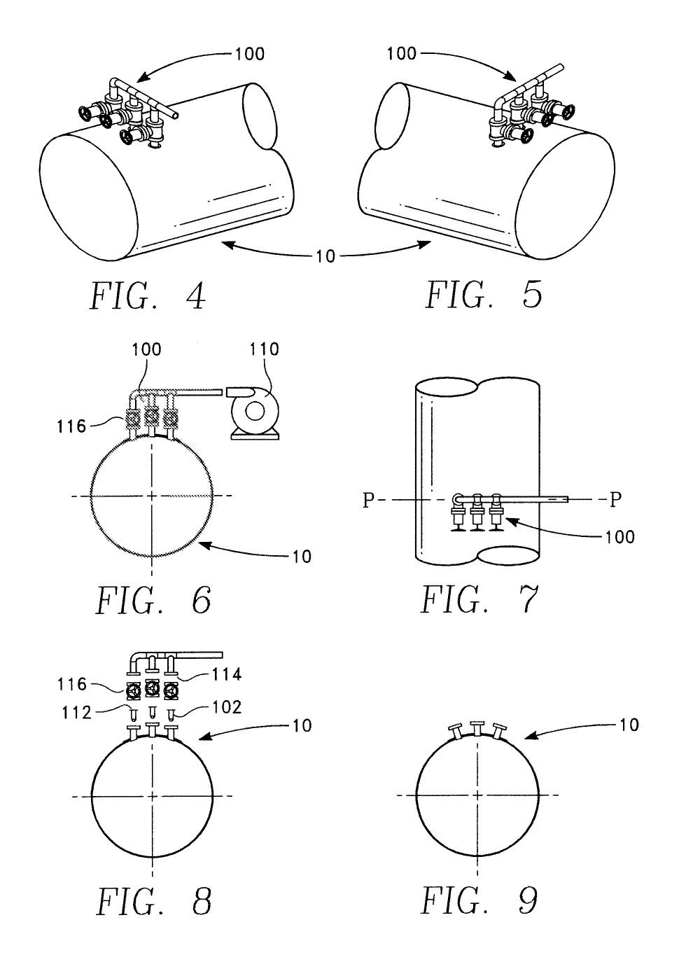

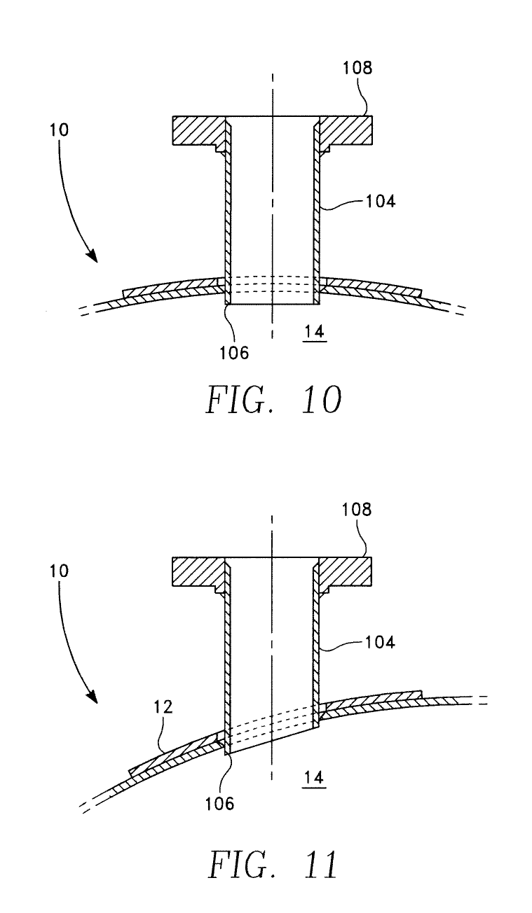

One or more plunging nozzle assemblies 100 are installed on the conduit 10 in a position which is adjacent to the upper section 14 of the conduit, as schematically indicated in FIG. 1 and shown in greater detail in FIGS. 2-10. As shown in FIGS. 2 and 3, a portion of a plunging nozzle 102 penetrates the wall 12 of the conduit 10. A pressurized liquid supply means, such as pump 110 schematically indicated on FIG. 6, is hydraulically connected to the plunging nozzle assembly 100, wherein pressurized liquid is pumped through the plunging nozzle assembly 100 when the gas phase is flowing adjacently to the plunging nozzle assembly within upper section 14. The pressurized liquid supply means, such as pump 110 and the plunging nozzle 102 are configured to discharge the pressurized liquid into the upper section 14 through the gas phase P_{G} and impacting an upper surface 20 of the liquid phase P_{L}, thereby entraining a portion of a gas in the gas phase P_{G} into the liquid phase. For example, the pressure and discharge rate of pump 110, the number of nozzle assemblies 100, and the throat diameter T and angle of dispersion of nozzle 102 may be adjusted to obtain efficient and effective mass transfer of the gas phase P_{G} into the liquid phase P_{L}.

As best shown in FIGS. 2A, 2B and 8, each nozzle assembly 100, 200 may comprise one or more nozzles 102 which are installed on the top side of the conduit 10, such that the nozzle assemblies will be adjacently disposed to any separated gas phase P_{G} which forms inside upper section 14. A plunging nozzle assembly comprises a sleeve member 104 having a first end 106 which penetrates the pipe wall and a second end 108 which may comprise a flange. A nozzle 102 slides inside the sleeve member 104, where the nozzle has a landing member 112 on one end which lands on the flange 108. At the opposite end of the nozzle 102 is the throat T of the nozzle which has a reduced diameter for jetting fluid which flows through the nozzle, where the throat of the nozzle is positioned to be downwardly facing into the interior I of the conduit 10. A mating flange 114 is made up to the flange 108 on the sleeve member 104 where the mating flange may be on a valve 116, spool piece, or other fitting.

In another embodiment, the invention comprises a generally circular conduit having a length L, where the conduit has an upper arcuate section 14. This upper arcuate section forms the headspace into which a separate gas phase P_{G} may form. The invention comprises a plurality of plunging nozzles 100 disposed within and penetrating the conduit wall 12 adjacent to the upper arcuate section. In this embodiment a set of nozzles 102 is mounted within a nozzle assembly 100, with the plurality of nozzles generally located at a distance L₁ from the gas injection point 18. In this embodiment, the nozzles 102 of the nozzle assembly 100 are arranged in circumferential alignment as indicated in FIGS. 2 and 3. The nozzles 102 may also be within the same axial plane P, as indicated in FIG. 7.

As best shown in FIG. 15, each nozzle 102 has a body 120 which has an axial opening 71 extending through the body, where an axis is defined by the orientation of the axial opening of each nozzle. A pressurized liquid supply means, such as pump 110 is attached to each plunging nozzle assembly 100, 200 for delivering a pressurized liquid in the conduit 10. The resulting liquid jet plunges though the surface 20 of the liquid phase P_{L} flowing through the conduit 10, carrying with it the gas that has accumulated in the headspace or upper section 14 within the separate gas phase P_{G}. Depending on the gas-liquid ratio and the velocity of the water flow in the conduit 10, the placement of the nozzle assembly 100 (or assemblies) are located at a point where the gas has accumulated and no longer is entrained and mixed with the water. Multiple sets of plunging nozzles may be placed along the length of a conduit to achieve the desired dissolution of the free gas phase. The use of multiple nozzle sets allows the utilization of lower liquid injection pressure at the nozzles, which means more nozzle sets can be operated with the same energy demand which, depending upon the volume of gas accumulated at the top of the conduit, accomplishes greater mass transfer. As shown in FIG. 2A, the axes of the axial openings of the plunging nozzles 102 may be mutually parallel. Alternatively, wherein a long axis is defined at the center of the conduit, the axes of the axial openings of the plunging nozzles may intersect at the long axis as shown in FIG. 3. Finally, an installation may comprise a first group of nozzle assemblies 100 which are configured as shown in FIG. 2, followed downstream by a second group of nozzle assemblies which are configured as shown in FIG. 3, and vice-versa.

In another embodiment of the invention, a bypass conduit 220, as taught within the '864 patent, extends into the unimpeded flow region of the conduit 210. The purpose of this bypass conduit 220 is to bypass a portion of the total liquid phase L_{G} stream and direct the bypass portion into one or more from mixer-injectors, which introduce into the bypass portion a correct amount of a desired treatment gas. Once the bypass portion has been treated with the desired treatment gas, the treated liquid is directed into at least one pair of injection nozzles that discharge the additive-laden fluid back into the conduit 210. This diversion/reinjection system is referred to as a pipeline flash reactor (“PFR”). In general, the plunging jets should be located 10 to 15 pipe diameters downstream from where the treatment gas is injected for the PFR at gas injection point 18.

A PFR was described in the '864 patent. The present invention may incorporate such a PFR as a component of the present invention. It has been through the application of the PFR that the issues associated with injection of high gas-liquid ratio liquids have been identified and giving rise to the need for the present invention.

The PFR may be described as having an upstream intake end 211 and an effluent end 212. Between these ends is a mixing region 213. The direction of total flow is shown by arrows 214. These ends and regions are at arbitrary locations within the conduit 10. For example, the ends are not necessarily ends of pipe segments, nor is region 213 well-defined. These items are given to designate respective generalized locations in the continued unimpeded flow through the conduit 210.

A bypass conduit 220 extends through the pipe wall 21 upstream of the region, and divides into two branches 222, 223.

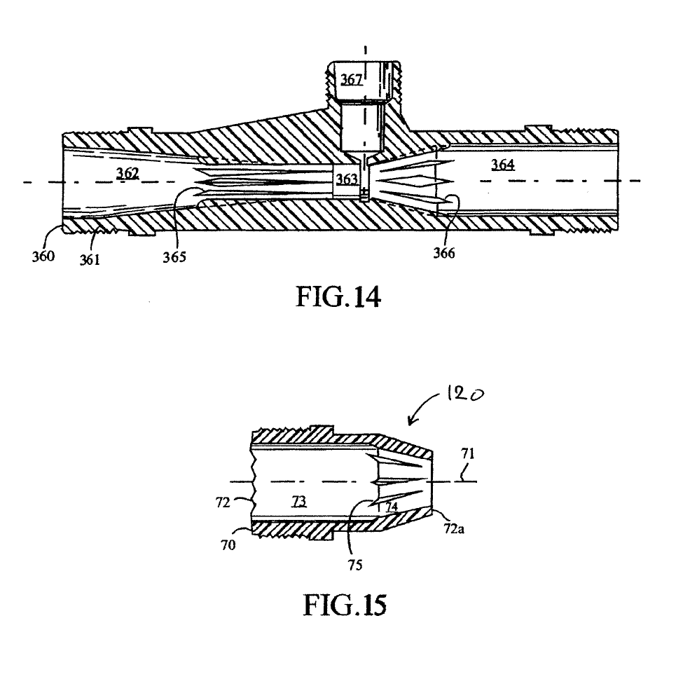

As best shown in FIG. 13, branch 222 flows into the intake 224 of a mixer-injector 225, and from its outlet divides into branches 230, 231. Branches 230, 231 discharge into respective nozzles 234, 235. Branch 223 includes identical elements, branches 230a and 231a, mixer-injector 225a, and nozzles 234a and 235a. Nozzles 234a and 235a may be identical to the nozzles 102 utilized in the nozzle assemblies 100 depending upon the desired performance characteristics.

Nozzles 234 and 235 have respective discharge axes 237, 238. Importantly, in the preferred construction these axis are coaxial and confrontational, directly across a major part of the cross-section of the pipe. When the pipe is circular they will intersect the center 239 of the lumen of the pipe. Similar relationships exist with nozzles 234 and 235 and their respective axes.

Coaxial discharge of the nozzles of this pair is preferred but optional. However, they should be in the same plane, but may make an angle with each other as the center of the pipe.

Treatment gas or other additives is supplied to the mixer injectors from a supply 240 which discharges to the respective mixer-injectors through pipes 241, 242. The additive used in this invention for large-scale operations will usually be ozone, but instead may be other treatment gases such as chlorine or oxygen or aqueous solutions of various types. The identity of the treatment substance is not a limitation in this invention. The term treatment substance is used for all fluid additives, the word fluid including both gases and liquids.

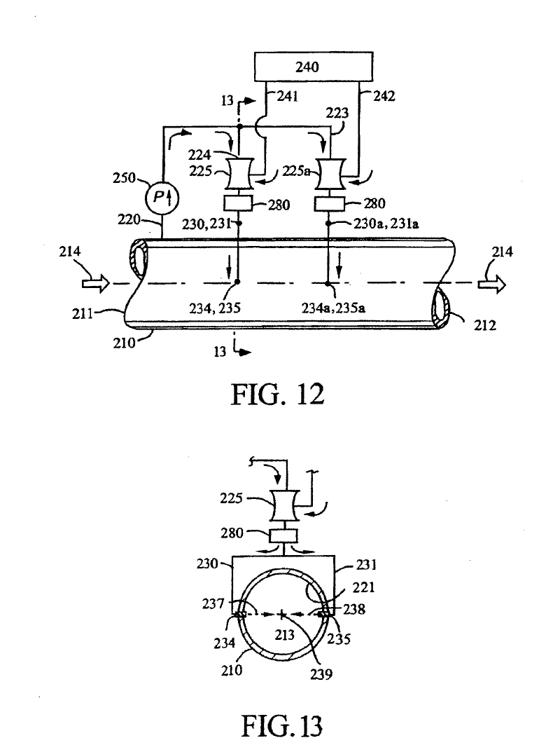

Two pairs of these nozzles, as shown in FIGS. 12 and 13 are preferable, although only one and as many as four pairs may be used. When more than one pair is provided, nozzles will preferably be axially aligned along the pipe as shown.

It does require some power to remove the bypass flow, pass it through the mixer-injector and return it to the main flow. An auxiliary pump 250 is provided for this purpose. Instead other known means to provide a differential passing may be utilized.

The ultimate objective of this embodiment of the invention is to inject treatment substances into the flowing confined system so that it is rapidly thoroughly distributed in the total flow, but where, if there is gas separation within the conduit 10 as discussed above, where the treatment gas can be re-entrained into the liquid phase P_{L}.

The mixing function of the PFR is addressed by the mixer-injector fully shown and described in Mazzei U.S. Pat. No. 5,863,128. FIG. 14 schematically shows such an injector. It is characterized by a body 360 having a circular passage 361 with a converging section 362, an injection section 363 and a diverging section 364. Twisting vanes 365 are formed on the wall of the converging section, and straightening vanes 366 are formed on the wall of the diverging section. Treatment gas from branch 367 is fed into the injection section. The structure and function of this mixer-injector will be fully understood from that patent, which is incorporated herein by reference in its entirety.

An acceptable nozzle for both the PFR and plunging nozzle 102 are shown in FIG. 14, which may be recognized as FIG. 3 of Mazzei U.S. Pat. No. 5,894,995, which patent is referred to herein and incorporated in its entirety for its showing of the preferred nozzle for use in this invention. This nozzle includes a body 70 with a central axis 71, an upstream end 72 and a discharge end 72a. Its internal inside bore 73 is reduced by a converging section 74 into which a plurality of twisting vanes 75 is placed. The result is to discharge a strong stream of water whose outside boundary is twisted relative to the inside “core” of the stream thereby providing a further mixing of the treatment substances. However, it is to be appreciated that other nozzles might be utilized.

With respect to the PFR, the nozzles of each pair of nozzles (i.e. 234, 235 and 234a and 235a) may be axially aligned as shown in FIGS. 12 and 13 and normal to the central axis of the stream and pointing within a plane which incorporates the central axis Testing of the PFR has shown this to be preferable to arrangements in which the nozzles are not normal to the axis of the stream. Divergence of a nozzle axis from a plane that is normal to the central axis is acceptable, within limits. It will be recognized that, while the discharged streams will be somewhat deflected by the main flow, depending on the velocity of the main flow, initial discharge normal to the axes of flow provides best results.

The principal objective of this invention of the PFR is to speed into a solution a treatment gas in an uniform manner within both the bypass liquid and within the main fluid flow contained within the conduit 10. This objective is further enhanced by the utilization of the plunging nozzles described herein.

A method of increasing the dissolution of a separated gas phase into a separate liquid phase, with both phases flowing together in a closed conduit is also disclosed and has the steps hereinafter described. The liquid phase P_{L} is introduced into the conduit 10 at a liquid inlet 211. A gas phase is P_{G} is introduced into the conduit 10 at a gas injection point 18 downstream of the liquid inlet 211. The introduction of the gas phase results in the separation of a separate gas phase P_{G} where most or substantially all of the gas phase is contained within the upper section 14 of the conduit 10, while a separate liquid phase P_{L} is substantially contained within the lower section 16. A liquid, either the same liquid flowing through the conduit (i.e., waste water or potable water) or a liquid from a separate source are pumped from a liquid supply means which is hydraulically connected to one or more plunging nozzle assemblies 100. The plunging nozzle assemblies are disposed on the conduit 10 adjacent to the upper section 14, with a portion of the plunging nozzle 102 penetrating the wall 12 of the conduit 10. The liquid is injected into the conduit 10 through the plunging nozzle 102 when the gas phase P_{G} is flowing in the upper section 14 immediately adjacently to the plunging nozzle 102. The pressurized liquid supply means, such as a pump 110 and the plunging nozzle 102 are configured to discharge the pressurized liquid into the upper section 14 through the gas phase P_{G} and impacting an upper surface 20 of the liquid phase P_{L}. This injection process entrains a portion of the gas phase P_{G} into the liquid phase P_{L}. This process may be repeated through several sets of plunging nozzle assemblies 100 set at different points in the conduit 10. For reactive gasses, the process may be treated along the length of the conduit 10 until there is reasonable confidence that the liquid phase P_{L} has been adequately exposed to the reactive substance. The mass transfer efficiency of the reactive components of the gas phase P_{G} to the liquid phase P_{L} is improved by the reshearing of the gas.

This invention is not to be limited by the embodiments shown in the drawings and described in the description, which are given by way of example and not of limitation, but only in accordance with the scope of the appended claims.

1. An apparatus for increasing the dissolution of reactants contained within a gas phase into a liquid phase comprising:
a generally circular conduit comprising a wall, the conduit having a length through which the liquid phase and the gas phase are simultaneously flowing under pressure in separated two phase flow wherein the gas phase has separated from the liquid phase, the conduit having an interior defined by the wall, the interior comprising an upper section and a lower section, wherein a majority of the gas phase is contained within the upper section and a majority of the liquid phase is contained within the lower section;
a plunging nozzle disposed only on a top side of the conduit adjacent to the upper section with the lower section having no plunging nozzles, a portion of the plunging nozzle penetrating the wall; and
a pressurized liquid supply means hydraulically connected to the plunging nozzle, wherein pressurized liquid is pumped through the plunging nozzle when the gas phase is flowing adjacently to the plunging nozzle, wherein the pressurized liquid supply means and the plunging nozzle are configured to discharge the pressurized liquid only into the upper section through the gas phase and impacting an upper surface of the liquid phase, thereby entraining a portion of a gas in the gas phase into the liquid phase.

2. The apparatus of claim 1 wherein the conduit comprises a plurality of plunging nozzles disposed circumferentially about the conduit adjacent to the upper section, wherein the pressurized liquid supply means is hydraulically connected to each plunging nozzle.

3. The apparatus of claim 1 wherein the plunging nozzle has an axial opening extending through a nozzle body, wherein an axis is defined by the orientation of the axial opening.

4. The apparatus of claim 2 wherein each of the plunging nozzles has an axial opening extending through a nozzle body, wherein an axis is defined by the orientation of the axial opening of each plunging nozzle.

5. The apparatus of claim 4 wherein the axes of the axial openings of the plunging nozzles are mutually parallel.

6. The apparatus of claim 4 wherein a long axis is defined at the center of the conduit and the axes of the axial openings of the plunging nozzles intersect at the long axis.

7. The apparatus of claim 1 wherein the liquid phase comprises water in a liquid state.

8. The apparatus of claim 1 wherein the gas phase comprises a gas selected from the group consisting of oxygen, ozone, chlorine and chlorine dioxide.

9. The apparatus of claim 1 wherein the gas phase is introduced into the conduit through an injection nozzle upstream of the plunging nozzle, where the distance between the injection nozzle and the plunging nozzle is L₁.

10. The apparatus of claim 9 wherein the conduit comprises a diameter D and L₁ equals D multiplied by a factor ranging from 10 to 15.

11. The apparatus of claim 9 further comprising a liquid bypass located upstream of the plunging nozzle, where the distance between the injection nozzle and the liquid bypass is L₂.

12. The apparatus of claim 11 wherein the liquid bypass comprises:
a suction end which receives a portion of the liquid flowing through the conduit;
a mixing assembly comprising a mixing injector having an inlet which receives the liquid from the suction end, an outlet, and a treatment gas entry port, said injector having an internal converging section at said inlet, an internal diverging section at said outlet, and between said converging and diverging sections, an injection section connected to said treatment gas entry port, and a source of treatment gas connected to said treatment gas entry port, wherein the outlet is hydraulically connected to the injection nozzle; and
a pump impelling water through said liquid by-pass, whereby with liquid flowing through said conduit, a portion of the liquid is received into the suction end and flows through said mixing injector, receives treatment gas from the treatment gas source and is returned to the conduit through the injection nozzle.

13. An apparatus for increasing the dissolution of reactants contained within a gas phase into a liquid phase comprising:
a generally circular conduit comprising a wall, the conduit having a length through which the liquid phase and the gas phase are simultaneously flowing under pressure in separated two phase flow, wherein the gas phase has separated from the liquid phase, the conduit having an interior defined by the wall, the interior comprising an upper section and a lower section, wherein a majority of the gas phase is contained within the upper section and a majority of the liquid phase is contained within the lower section;
a plurality of plunging nozzles disposed circumferentially about only on a top side of the conduit adjacent to the upper section, a portion of each nozzle penetrating the wall, with the lower section having no plunging nozzles; and
a pressurized liquid supply means attached to the plunging nozzles, wherein pressurized liquid may be selectively pumped through one or more of the plunging nozzles when the gas phase is flowing adjacently to the one or more plunging nozzles.

14. The apparatus of claim 13 wherein each of the plunging nozzles has an axial opening extending through a nozzle body, wherein an axis is defined by the orientation of the axial opening of each plunging nozzle.

15. The apparatus of claim 14 wherein the axes of the axial openings of the plunging nozzles are mutually parallel.

16. The apparatus of claim 14 wherein a long axis is defined at the center of the conduit and the axes of the axial openings of the plunging nozzles intersect at the long axis.

17. In a conduit comprising a wall, the conduit having a length through which the liquid phase and the gas phase are simultaneously flowing in separated two phase flow, the conduit having an interior defined by the wall, the interior comprising an upper section and a lower section, a method for increasing the dissolution of a gas phase into a liquid phase comprises the following steps:
introducing a liquid phase into the conduit at a liquid inlet under pressure;
introducing a gas phase into the conduit at a gas injection point downstream of the liquid inlet, where such introduction results in the liquid phase and the gas phase to simultaneously flow in a separated two phase flow, wherein substantially all of the gas phase is contained within the upper section and substantially all of the liquid phase is contained within the lower section;
pumping a liquid from a pressurized liquid supply means hydraulically connected to a plunging nozzle disposed only into a top side of the conduit adjacent to the upper section, a portion of the plunging nozzle penetrating the wall with the lower section having no plunging nozzles; and
injecting the liquid into the conduit through the plunging nozzle when the gas phase is flowing in the upper section immediately adjacently to the plunging nozzle, wherein the pressurized liquid supply means and the plunging nozzle are configured to discharge the pressurized liquid into the upper section through the gas phase and impacting an upper surface of the liquid phase, thereby entraining a portion of a gas in the gas phase into the liquid phase.

18. An apparatus for increasing the dissolution of reactants within a gas phase into a liquid phase comprising:
a generally circular pressurized conduit having a length through which the liquid phase and the gas phase are simultaneously flowing, the conduit having an upper arcuate section;
a first plunging nozzle disposed only within a top side of the conduit and penetrating the upper arcuate section at a first point located a distance L₁ along the length wherein an axial plane normal to the conduit is defined at distance L₁, the first plunging nozzle having a first body comprising a first axial opening extending through the first body, wherein a first axis is defined by the orientation of the first axial opening;
a second plunging nozzle disposed only within the top side of the conduit and penetrating the upper arcuate section at a second point located at a distance L₁ along the length, the second plunging nozzle in circumferential alignment with the first plunging nozzle, the second plunging nozzle having a second body comprising a second axial opening extending through the second body, wherein a second axis is defined by the orientation of the second axial opening;
a third plunging nozzle disposed only within the top side of the conduit and penetrating the upper arcuate section at a third point located at a distance L₁ along the length, the third plunging nozzle in circumferential alignment and in the same axial plane with the first plunging nozzle and the second plunging nozzle, the third plunging nozzle having a third body comprising a third axial opening extending through the third body, wherein a third axis is defined by the orientation of the third axial opening;
wherein the lower section has no plunging nozzles; and
a pressurized liquid supply means attached to the first plunging nozzle, the second plunging nozzle, and the third plunging nozzle for delivering a pressurized liquid into the conduit.

19. The apparatus of claim 18 wherein the first axis, the second axis, and the third axis are mutually parallel.

20. The apparatus of claim 18 wherein the first axis, the second axis, and the third axis intersect at the approximate center of the conduit.
